(19) United States
(12) Patent Application Publication
(10) Pub. No.: US 2025/0285854 A1
(43) Pub. Date: Sep. 11, 2025

(54) Detector Bias Optimization and Monitoring on the Fly

(71) Applicant: DH Technologies Development Pte. Ltd., Singapore (SG)

(72) Inventor: Samad BAZARGAN, Brampton (CA)

(73) Assignee: DH Technologies Development Pte. Ltd., Singapore (SG)

(21) Appl. No.: 18/858,607

(22) PCT Filed: Apr. 21, 2023
(86) PCT No.: PCT/IB2023/054113

§ 371 Date: Oct. 21, 2024

Related U.S. Application Data
(60) Provisional application No. 63/333,898, filed on Apr. 22, 2022.

(51) Int. Cl. H01J 49/02; H01J 49/00

(52) U.S. Cl. CPC H01J 49/025; H01J 49/0036

(57) ABSTRACT

In one aspect, a method for monitoring a bias voltage applied to an ion detector of a mass spectrometer is disclosed, which comprises applying an initial bias voltage to the ion detector, using the ion detector with the initial bias voltage applied thereto to acquire at least two viable ion detection signals corresponding to at least two different ion signal detection threshold values, and using said at least two viable ion detection signals to determine whether an adjustment of said bias voltage is required.

### RELATED APPLICATIONS

This application claims priority to U.S. provisional application No. 63/333,898 filed on Apr. 22, 2022, entitled “Detector Bias Optimization and Monitoring on the Fly,” which is incorporated herein by reference in its entirety.

### TECHNICAL FIELD

The present disclosure is generally directed to methods and systems for monitoring a bias voltage, and/or maintaining an optimal value for the bias voltage applied to an ion detector in a mass spectrometer, e.g., such methods and systems for determining whether the detector bias voltage deviates from its optimal setting.

### BACKGROUND

In mass spectrometry, a bias voltage is typically applied to an ion detector employed to detect ions. The bias voltage is typically adjusted to optimize the performance of the mass spectrometer. By way of example, the optimization of an ion detector bias voltage traditionally involves introducing a steady stream of an analyte into the mass spectrometer and measuring the intensity of an ion associated with that analyte while ramping the bias voltage. The optimal bias voltage may be chosen, for example, to correspond to a bias voltage at which an increase in the bias voltage will not result in any further substantial increase in the observed ion intensity. An example of such a criterion defines the optimal bias voltage as the first bias voltage during an increasing bias voltage ramp that fails to result in an increase of at least 30% in the ion signal intensity.

Traditionally, the users of a mass spectrometer check the detector bias voltage infrequently to monitor whether it has drifted from its optimal value. In fact, the users usually recognize that an adjustment of the ion detector bias voltage is needed only when a significant degradation of the ion detection intensities is observed.

### SUMMARY

In one aspect, a method for monitoring a bias voltage applied to an ion detector of a mass spectrometer is disclosed, which comprises applying an initial bias voltage to the ion detector, using the ion detector with the initial bias voltage applied thereto to acquire at least two viable ion detection signals corresponding to at least two different ion signal detection threshold values, and using said at least two viable ion detection signals to determine whether an adjustment of the bias voltage is required.

In some embodiments, a ratio of the signal intensities of the two viable ion detection signals is compared with a reference value to determine whether the ratio lies within a predefined tolerance range of the reference value. When the ratio lies outside of the predefined range, an adjustment of the bias voltage is indicated. The tolerance range can be, for example, about +/−5%, +/−10%, +/−20% of the reference value, though other ranges can also be employed, e.g., based on the requirements of a particular application.

In some embodiments, the degree of deviation of a bias voltage from a target value (which is typically an optimal value) associated with a ratio of two viable ion detection signal intensities corresponding to two different discriminator threshold values can be computed by employing previously-obtained reference data to determine whether an adjustment of the bias voltage is needed.

In some cases, in response to an indication that an adjustment of the bias voltage is needed, the bias voltage can be adjusted such that the bias voltage is brought within an acceptable tolerance range of an optimal bias voltage. In some embodiments, a user can adjust the bias voltage in response to an indication that an adjustment is required. In other embodiments, such adjustment of the bias voltage can be achieved automatically, e.g., via a feedback loop.

In some embodiments, the adjustment of the bias voltage can be achieved by adding a corrective voltage to or subtracting a corrective voltage from the bias voltage under examination. In some implementations of such an embodiment, the required corrective voltage can be obtained from a look-up table that contains a plurality of corrective voltages corresponding to a plurality of ratios of intensities associated with at least two viable ion signal intensities.

In some embodiments, the adjusted bias voltage is examined in a manner discussed above, i.e., by comparing the ratios of intensities of at least two viable ion detection signals with a reference value to determine whether the intensity ratio is within an acceptable tolerance range of the reference value. If the ion signal intensity ratio (or bias voltage deviation from the target value (typically the optimal value) inferred based on the ion signal intensity ratio) is found not to be within an acceptable tolerance range, the adjustment and examination of the bias voltage is iterated until arriving at an acceptable bias voltage.

A variety of ion detectors can be employed in the practice of the present teachings. Some examples of such ion detectors include, without limitation, channel electron multipliers, discrete dynode multipliers, microchannel plate detectors, among others. Further, the present teachings can be practiced for adjusting the bias voltage of ion detectors in a variety of different mass spectrometers employing a variety of different mass analyzers. Some examples of such mass analyzers include, without limitation, a time-of-flight (ToF) mass analyzer, a quadrupole mass analyzer, and a combination thereof.

In some embodiments, the method further includes generating a notification when an adjustment of the bias voltage is required. Such a notification can take a variety of forms, e.g., it can be a visual and/or an auditory notification.

In some embodiments, the process of examining a bias voltage applied to an ion detector can be triggered (i.e., initiated) at one or more times during a mass spectrometric analysis of a compound. By way of example, a user can initiate the examination of the bias voltage at such times, or alternatively, such examination of the bias voltage can be initiated automatically at one or more predefined times.

In some embodiments, the examination of the bias voltage applied to the ion detector can be initiated after the passage of a predefined time period subsequent to the time at which the ion detector is triggered to begin ion detection.

In some embodiments, any of the viable ion detection signals can be acquired by amplifying an ion detection signal generated by the ion detector in response to detection of ions incident thereon, and comparing the amplified ion detection signal relative to a discriminator threshold value to accept an ion detection signal as a viable ion detection signal when the signal (i.e., the detected voltage) exceeds the discriminator threshold value during a certain temporal portion of the signal (e.g., for a duration of at least 1.3 nanosecond or as required by the specifications of the comparator circuitry). In some embodiments in which an analog ion detection signal is digitized, a variety of criteria can be employed to arrive at a viable ion detection signal. One example of such a criterion is to require that the signal, subsequent to having been subjected to smoothing and/or other processing to reduce signal noise, be above a predefined threshold.

In some embodiments, the acquisition of any of said at least two viable ion detection signals can be achieved by amplifying an ion detection signal generated by the ion detector in response to detection of ions incident thereon to generate an amplified ion detection signal and digitizing the amplified ion detection signal to generate a digital ion detection signal. The digital ion detection signal can then be processed via comparison with a plurality of discriminator threshold values to generate a plurality of ion detection intensities each corresponding to one of the discriminator threshold values. The ion detection intensities can then be employed to determine whether an adjustment of the bias voltage is required.

In a related aspect, a method of monitoring a bias voltage applied to an ion detector of a mass spectrometer is disclosed, which includes dividing an ion detection signal generated by an ion detector to which an initial bias voltage is applied among a plurality of ion signal processing channels each configured to process the received ion detection signal relative to a different discriminator threshold voltage to generate a plurality of viable ion detection signals each corresponding to a respective one of the discriminator threshold voltages and comparing the viable ion detection signals, e.g., relative to a reference, to determine whether the bias voltage corresponds to an optimal bias voltage.

While in some embodiments the comparison of the digital ion detection signals acquired at different discriminator threshold values with a reference can be performed in real-time (i.e., during an experimental run), in other embodiments the comparison of the digital ion detection signals with the predefined reference can be performed subsequent to the termination of the data acquisition of an experimental run. In some implementations of the latter embodiment, the data corresponding to the digital ion detection signals and the respective discriminator threshold values can be stored in a database, which can be accessed to retrieve the data and process the data in a manner disclosed herein to determine whether an adjustment of the bias voltage applied to the ion detector is needed. In some embodiments, such information can be employed in post-processing of the data to apply a correction factor (herein also referred to as a scaling factor) to the data to compensate for deviation, if any, of the bias voltage applied to the ion detector during the acquisition of the mass analysis data.

For example, in some embodiments in which the analysis of the detected viable ion detection signals obtained at different discriminator threshold values is performed after completion of data acquisition, e.g., after completion of an experimental run, a corrective voltage (delta voltage) derived for the bias voltage based on analysis of the data in accordance with the present teachings can be utilized to arrive at a corrective scaling factor for adjusting the detected viable ion signal intensities. In other words, the corrective scaling factor can be determined based on a difference between the applied bias voltage (i.e., the bias voltage employed for data acquisition) and an optimal bias voltage determined via post-processing of the data based on the present teachings.

In a related aspect, a method of monitoring a bias voltage applied to an ion detector of a mass spectrometer is disclosed in which for each of a reference optimal bias voltage, at least one reference bias voltage less than the optimal bias voltage and at least one reference bias voltage greater than the optimal bias voltage, an ion signal intensity ratio of two measured ion detection signals each acquired at a different discriminator threshold value is obtained. The reference bias voltages and their respective ion intensity ratios are used to compute a difference, if any, between the measured bias voltage relative to a target value (typically an optimal value) corresponding to a measured ratio of two ion detection signals each acquired at one of said different discriminator threshold values. When the computed bias voltage difference from the target value is not within the tolerance range, the bias voltage can be optionally adjusted to bring it within the acceptable tolerance range.

In a related aspect, a method of monitoring, adjusting and/or maintaining a bias voltage applied to an ion detector of a mass spectrometer is disclosed, which includes applying a bias voltage ramp to the ion detector by increasing the bias voltage by a plurality of discrete steps so as to apply a plurality of discrete bias voltages to the ion detector. At each discrete voltage value, ion intensities at two or more discriminator threshold voltages are measured. And the ion intensities are processed, e.g., via obtaining a ratio thereof or otherwise as disclosed herein, to obtain an intensity parameter (e.g., the intensity parameter can correspond to the ratio of two ion intensities acquired at two different discriminator threshold voltages). The intensity parameters are then utilized as calibration data (e.g., in the form of a calibration curve), which can then be used to determine whether a measured bias voltage is within an acceptable range of an optimal bias voltage or lies outside that range, either above or below the optimal bias voltage.

In a related aspect, a system for monitoring a bias voltage applied to an ion detector of a mass spectrometer is disclosed, which includes a signal processing circuitry configured to receive ion detection signals generated by the ion detector in response to detection of ions incident thereon and to amplify the ion detection signals to generate a plurality of amplified ion detection signals, and a controller in communication with the signal processing circuitry for receiving the amplified signals, where the controller is configured to process the amplified ion detection signals to identify a plurality of viable ion detection signals corresponding to a plurality of different discriminator threshold values. The controller can be further configured to compute intensities of the viable ion detection signals at the plurality of different discriminator threshold values and process those ion intensities to determine whether an adjustment of the bias voltage is required. In some such embodiments, an adjustable DC voltage source in communication with the controller can be configured to supply the bias voltage to the ion detector. By way of example, the controller can be configured to provide one or more control signals to the adjustable voltage source when an adjustment of the bias voltage is required to cause the voltage source to adjust the bias voltage. In some such embodiments, the controller can be in communication with a database to access a corrective bias voltage and can be configured to provide the corrective bias voltage to the adjustable voltage source via those control signal(s).

In a related aspect, a mass spectrometer is disclosed, which includes an ion source for receiving an analyte and ionizing the analyte to generate at least one analyte ion, and a mass analyzer that is positioned downstream of the ion source for detecting any of the analyte ion and/or fragments thereof to generate one or more ion detection signals. The mass spectrometer further includes an adjustable DC voltage source for generating a bias voltage for application to the ion detector. The mass spectrometer can further include at least one circuitry for amplifying the ion detection signals, or otherwise processing those signals, and comparing each amplified ion detection signal with a discriminator threshold value to generate a plurality of viable ion detection signals. A controller in communication with the circuitry can receive the viable ion detection signals and compare the signals obtained at different discriminator threshold values to determine whether an adjustment of the bias voltage is needed. In some embodiments, the controller can be also in communication with the DC adjustable voltage source to send one or more control signals to the DC voltage source for adjusting the bias voltage, when such an adjustment is needed, so as to bring the bias voltage applied to the ion detector within an acceptable tolerance range of an optimal value. In some embodiments, the circuitry for amplifying the ion detection signals can be integrated with the ion detector electronics circuitry while in other embodiments, the circuitry can be implemented separately from the ion detector's electronics circuitry.

Further understanding of various aspects of the present teachings can be obtained with reference to the following detailed description and in conjunction with the associated drawings, which are described briefly below.

### BRIEF DESCRIPTION OF THE DRAWINGS

FIG. 1 shows variation of ion mass signal intensity associated with a Poly (propylene glycol) ion at m/z=906.673 as a function of an increase of a bias voltage applied to an ion detector utilized to acquire the mass signals,

FIGS. 2A, and 2B show, respectively, an example of an amplified signal from a capacitively coupled detection system with a graphical threshold level set on the positive portion of the ion strike events, where ion events that are above this limit are considered viable and will be counted, and an example peak height distribution corresponding to detector pulses that were collected at a plurality of different bias voltages and at a peak detection threshold (i.e., a discriminator threshold) of 15 mV,

FIG. 3A shows a graph depicting an example of average pulse heights above threshold as a function of increasing bias voltage.

FIGS. 3B and 3C show the respective pulse height distribution and pulse height cumulative distribution corresponding to the data presented in FIG. 3A,

FIG. 3D shows an example of the frequency of pulse height voltage associated with an ion detection signal generated by an ion detector for several bias voltages applied to the ion detector including the optimal bias of 1600 v and for bias voltages of 1400 v and 1800 v, which are 200 v below and above the optimal bias voltage, respectively,

FIG. 4A is a flow chart depicting various steps in a method according to an embodiment of the present teachings for examining a bias voltage applied to an ion detector of a mass spectrometric system,

FIG. 4B is a flow chart depicting various steps in a method according to an embodiment of the present teachings for monitoring a bias voltage applied to an ion detector of a mass spectrometric system,

FIG. 4C shows an example of an optimal bias voltage that is set at about 1500 volts with the dashed lines U and L indicating an upper and a lower error margin of about 50 volts,

FIG. 5A is a flow chart depicting various steps in an implementation of a method according to an embodiment of the present teachings in which a plurality of ion signal intensities at different discriminator threshold values is sequentially acquired,

FIG. 5B depict an example of a system according to an embodiment for examining a bias voltage applied to an ion detector of a mass spectrometer,

FIG. 5C depicts a partial schematic view of a discriminator circuit suitable for use in the system illustrated in FIG. 5B,

FIG. 5D is a flow chart depicting various steps in an embodiment of a method according to the present teachings in which a plurality of ion signal intensity measurements at different discriminator threshold values are obtained, for example, over a plurality of dwell times,

FIG. 6A is a flow chart depicting various steps in a method according to the present teachings in which ion detection signals generated by an ion detector are digitized and the digital signals are processed in accordance with the present teachings to determine whether an adjustment of a bias voltage applied to the ion detector is required,

FIG. 6B is a flow chart depicting various steps of an example of implementation of a system according to an embodiment of the present teachings for monitoring and optionally adjusting a bias voltage applied to an ion detector,

FIG. 6C is a flow chart depicting various steps employed in an embodiment for processing a digital signal corresponding to an ion detection event for determining whether a bias voltage applied to the ion detector needs adjustment,

FIG. 7A is a flow chart depicting various steps in a method according to an embodiment for examining a bias voltage applied to an ion detector,

FIG. 7B schematically depicts that in one embodiment, a controller can be initialized to start the bias optimization process, where at each cycle it is determined whether a bias voltage adjustment is needed and if the criterion for adjustment is met, bias voltage delta is determined from a look-up table and is applied to the ion detector. The counter index is then incremented and the sequences in the cycle repeat until either bias does not need adjustment or until a predetermined number of cycles, for example 5, have occurred in this iteration based on the counter index,

FIG. 8 is a schematic view of a mass spectrometer according to an embodiment of the present teachings in which a system for monitoring and adjusting a bias voltage applied to an ion detector according to the present teachings is incorporated, and

FIG. 9 is an example of an implementation of a controller and/or an analysis module suitable for use in the practice of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed in any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The present disclosure relates generally to methods and systems for monitoring/adjusting and/or maintaining a bias voltage applied to an ion detector of a mass spectrometer. As discussed in more detail below, in some embodiments the systems and methods according to the present teachings can be employed to set the bias voltage at an optimal value and/or to determine whether a bias voltage applied to such a n ion detector has changed from its optimal value by more than an acceptable tolerance margin.

The term “a viable ion detection signal,” as used herein refers to an ion detection signal that has an intensity greater than a predefined discriminator threshold value, e.g., over a predefined temporal extent of the ion detection signal.

The term “a discriminator threshold value” or “a discriminator threshold voltage,” or simply a “a threshold voltage” or “a threshold value” are used herein interchangeably to refer to a reference voltage against which an amplified ion detection signal is compared to determine whether the ion detection signal is a viable ion detection signal.

An optimal setting for a bias voltage applied to an ion detector is conventionally determined by monitoring the intensity of a stable mass signal as the bias voltage is ramped in a number of steps. Generally, a dwell time of 1 second per ramp step is required.

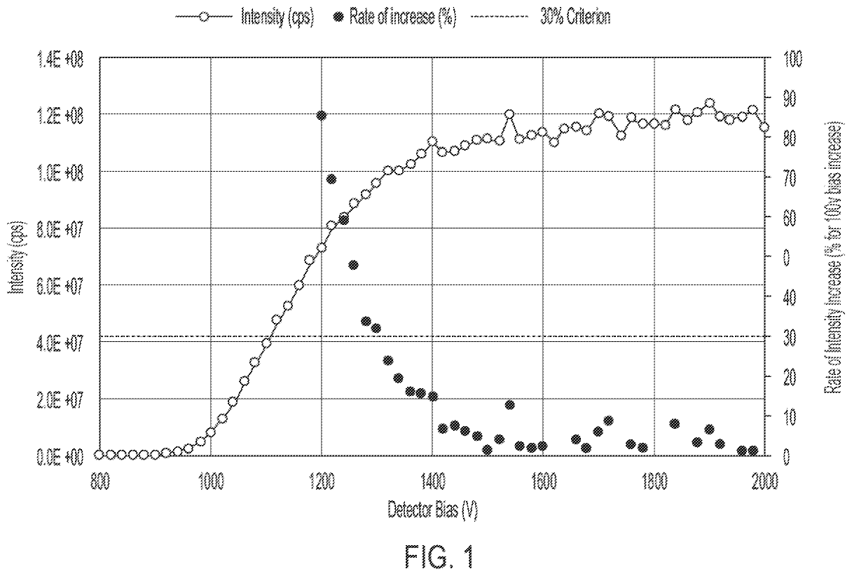

By way of illustration, FIG. 1 shows variation of ion mass signal intensity associated with a Poly (propylene glycol) ion at m/z=906.673 as a function of an increase of the bias voltage applied to an ion detector utilized to acquire the mass signals. The data was obtained using a prototype Sciex triple quad 7500 mass spectrometer. The optimal bias voltage is conventionally chosen based on the rate of increase of the ion mass signal intensity. An example of a criterion for selecting an optimal bias voltage considers the optimal bias voltage as the lowest voltage at which the ion signal intensity at that bias voltage fails to increase by 30% or more of the ion mass signal intensity at a bias voltage that is 100 volts lower than the optimal value (See, the dashed line in FIG. 1). Another example of such a criterion defines the optimal bias voltage as the first bias voltage during an increasing bias voltage ramp at which the ion signal fails to increase by at least 30%.

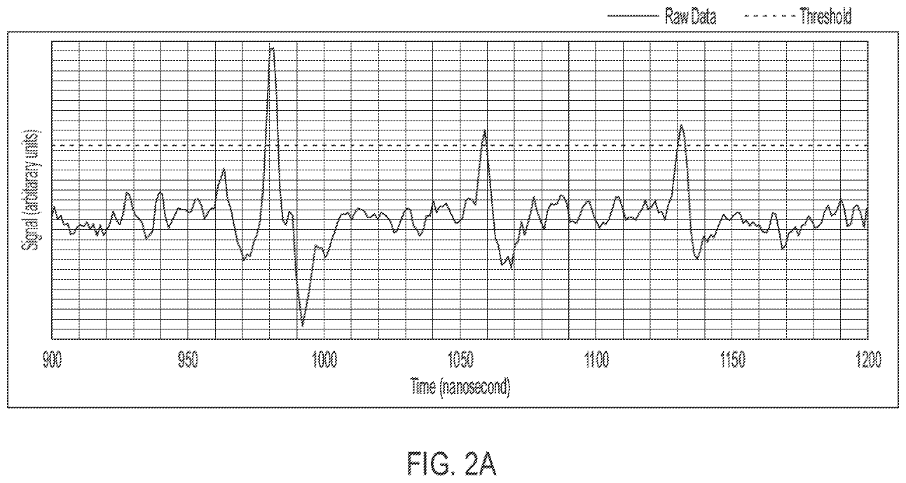

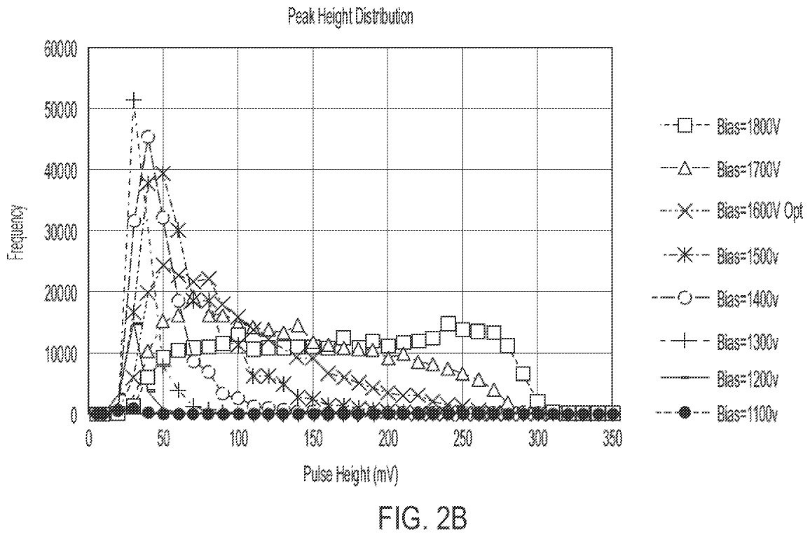

By way of further illustration, FIG. 2A shows raw ion detection signals with signals having a portion with an intensity exceeding the depicted threshold being considered as viable signals. In this example, the ion detection signals exhibit a derivative shape due to the capacitively coupled signal acquisition technique that was employed. Hence, the threshold can be applied to both the positive and the negative portions of the raw signal depicted in FIG. 2A. FIG. 2B shows a peak height distribution extracted from such raw data corresponding to detector pulses that were collected at a plurality of different bias voltages and at a peak detection threshold (i.e., a discriminator threshold) of 15 mV. The optimal bias voltage was determined to be 1600 V based on the conventional method of ramping the bias voltage as discussed above.

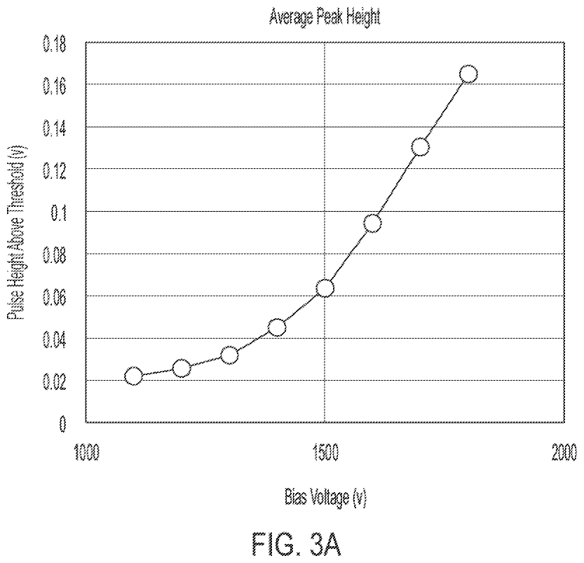

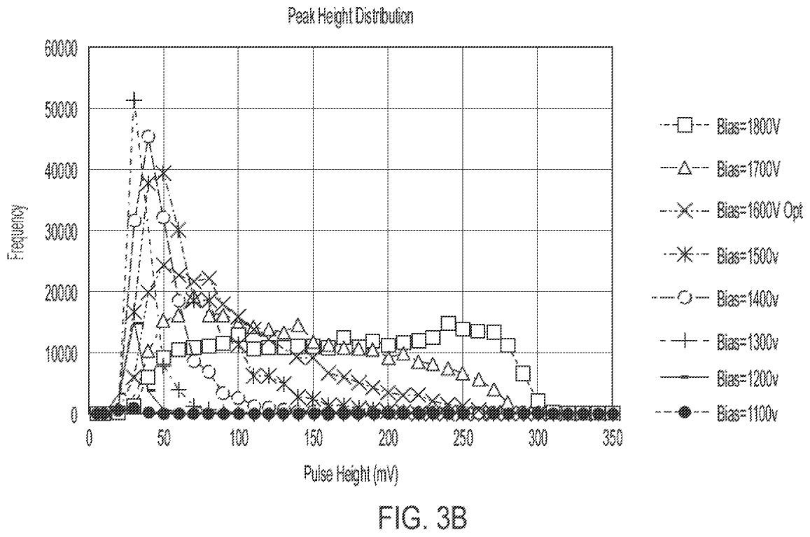

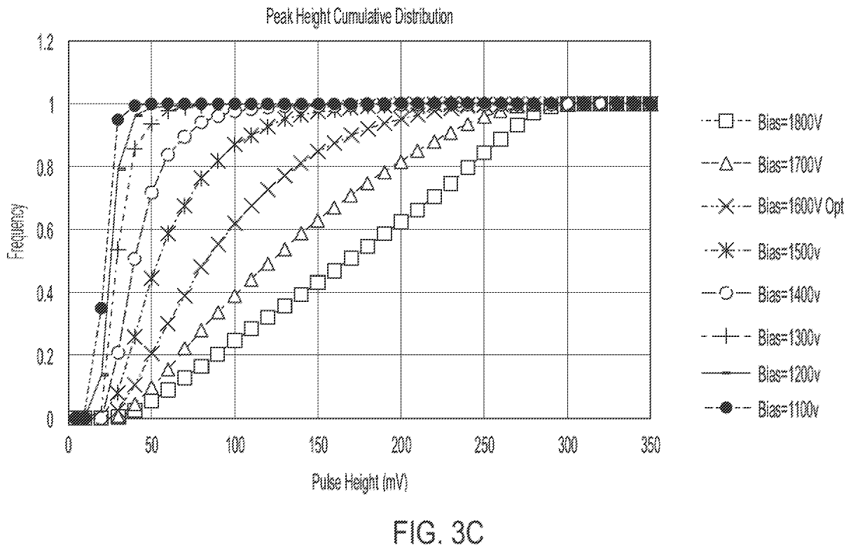

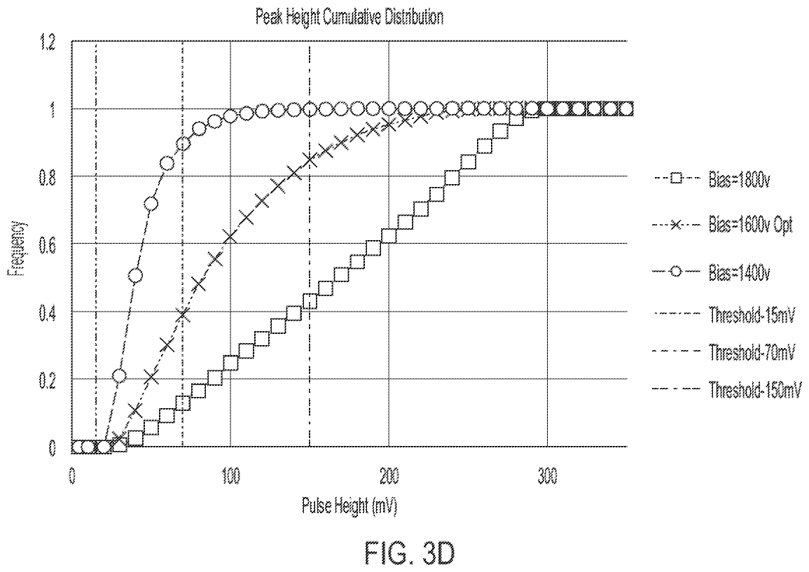

In general, the pulse height of a voltage pulse generated by an ion detector in response to detection of one or more incident ions is the main parameter that is utilized for bias voltage optimization. For example, in some cases, the process of bias voltage optimization can be viewed as adjusting the gain of an ion detector so that nearly 90% of the pulses in the distribution would have a height above the discriminator threshold value. Increasing the bias voltage shifts the peak height distribution to a higher average height and further changes the overall pulse height distribution. By way of illustration, FIG. 3A shows a graph depicting an example of average pulse heights above a discriminator threshold value as a function of increasing bias voltage obtained for Poly (propylene glycol) ion at m/z=906.673 using a prototype Sciex triple quad 7500 mass spectrometer. FIGS. 3B and 3C show the respective pulse height distribution and pulse height cumulative distribution. A clear distinction can be observed between the pulse height distributions near the optimal bias voltage of 1600 V.

In order to examine the pulse height cumulative distribution at a given bias voltage, two or more discriminator threshold values can be used to measure the ion detection signal. As shown schematically in FIG. 3D, this approach can be viewed as moving a vertical line (See, lines A, B, and C) on the pulse height axis of the distribution to a new value and allow only those pulses with a height to the right of the vertical line to contribute to the observed cumulative intensity. The present teachings are at least in part based on the recognition that the ratio of ion detection signals measured at different discriminator threshold voltages is related to the shape of the pulse height distribution and hence can be used as a gauge for determining whether the bias voltage is optimized.

In general, in many embodiments, the discriminator threshold values utilized to assess the bias voltage applied to an ion detector are selected in a region in which the pulse height distribution exhibits the greatest sensitivity to bias voltage changes. By way of example, the discriminator threshold values can be in a range of about 50 mV to about 200 mV, though other ranges can also be employed based on the characteristics of an instrument under examination.

As discussed in more detail below, in some embodiments, for a given bias voltage, if the drop in the ion detection signal intensity at a higher discriminator threshold value relative to a lower discriminator threshold value is greater than a predetermined value (i.e., if the ratio of the signal intensity at the higher discriminator threshold value relative to the lower discriminator threshold value is less than a reference value), the bias voltage is less than the optimal value, and if the drop is less than the predetermined value, the bias voltage is greater than the optimal value.

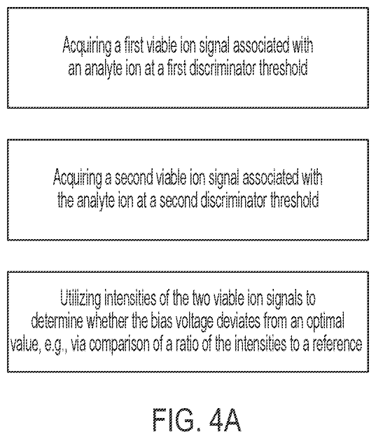

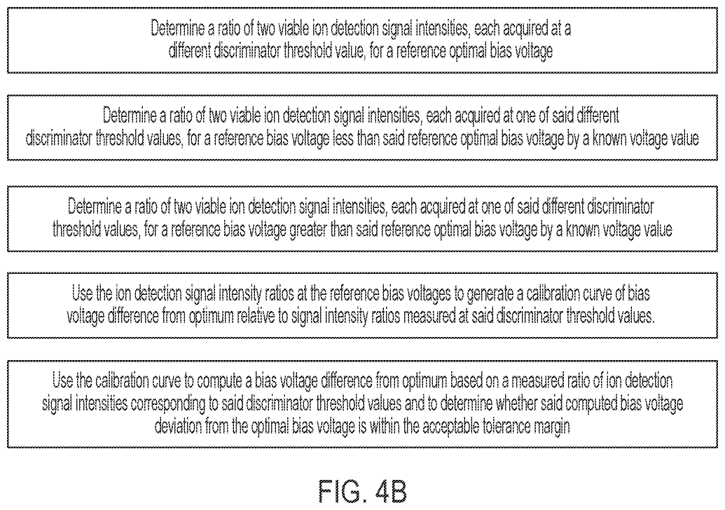

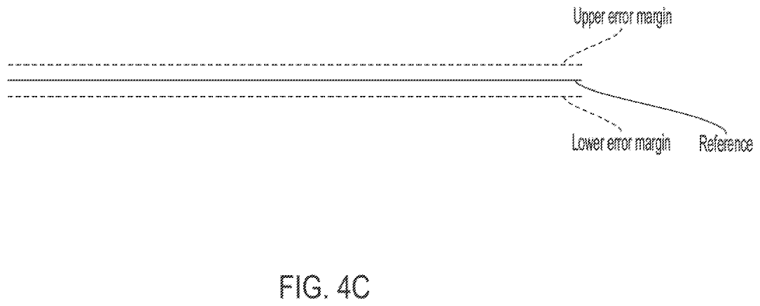

With reference to the flow chart of FIG. 4A, one embodiment of a method according to the present teachings for examining a bias voltage applied to an ion detector includes acquiring a first viable ion signal associated with an analyte ion at a first discriminator threshold value and acquiring a second viable ion signal associated with the analyte ion at a second discriminator threshold value. The intensities of the two viable ion signals can then be utilized to determine whether an adjustment of the applied bias voltage is required. For example, a ratio of the two intensities can be compared with a reference value to determine whether the bias voltage deviates from an optimal value. For example, if the ratio of the two ion intensities is greater or less than the reference value by more than a predefined error margin, the method can notify a user that an adjustment of the bias voltage is recommended. In some embodiments, instead of or in addition to notifying a user, the method can include a step of automatically adjusting the bias voltage when an adjustment of the bias voltage is needed to bring the bias voltage within an acceptable error margin of a predefined optimal bias voltage.

With reference to FIG. 4B, in some embodiments, ion signal intensities at two or more discriminator threshold values are measured for (1) an optimal reference bias voltage, (2) at a bias voltage greater than the optimal bias voltage by a certain voltage value (e.g., 100 volts), and (3) at a bias voltage less than the optimal bias voltage by a certain voltage value (e.g., 100 volts). Such reference ion signal intensity ratios can then be employed to process a measured ion signal intensity ratio corresponding to two or more discriminator threshold values to determine a deviation, if any, from the optimal bias voltage. For example, the reference bias voltage difference from optimal values can be fitted to a function (e.g., a linear function) to obtain a calibration curve, which can be used to correlate a measured ion intensity ratio to a bias voltage deviation from the optimal bias voltage. If the deviation of the bias voltage from the optimal bias voltage is determined to be outside an acceptable tolerance range, the bias voltage can be corrected (e.g., by adding or subtracting an appropriate delta voltage) to bring the bias voltage within the acceptable tolerance range.

By way of further illustration, consider a case in which at an optimal bias voltage, ion intensities at discriminator threshold values of 15 mV and 60 mV are, respectively, 1e6 cps and 7e5 cps, resulting in an ion intensity ratio of 0.7. Further, at a bias voltage that is 100 volts less than the optimal value, ion intensities of 9e5 cps and 3.7e5 cps corresponding to 15 mV and 60 mV, and at a bias voltage that is 100 volts greater than the optimal value, ion intensities of 1.1e6 cps and 9.24e5 cps corresponding to 15 mV and 60 mV, may be measured. Such reference values can then be utilized to monitor and adjust the bias voltage accordingly. For example, a measured intensity ratio of 0.8 would indicate that the bias voltage is above the optimal value by about 70 volts, e.g., by using linear interpolation between the reference intensity ratios corresponding to the optimal bias voltage and to the bias voltage that is 100 V above the optimal value.

By way of example, FIG. 4C shows a reference optimal bias voltage that is set at about 1500 volts. The dashed lines U and L indicate an upper and a lower error margin of about 50 volts relative to the optimal bias voltage. In such an implementation, when the ratio of ion intensities corresponding to two viable ion signals, each measured at a different discriminator threshold value, indicates a bias voltage deviation from the optimal bias voltage by more than 50 volts, a correction of the bias voltage is initiated.

Without being limited to any particular theory, as noted above, a change in the ratio of the ion signal intensities at different discriminator threshold values relates back to the cumulative peak height distribution, which is a function of the detector bias voltage deviation from the optimal value. The rate of change in the ion intensity as the discriminator threshold value is increased or decreased can be used to determine if the detector bias voltage is higher or lower than the desired optimal bias voltage. The detector bias voltage can then be increased or decreased accordingly.

In some embodiments of the above method, in response to the determination that the bias voltage has changed from an optimal value by more than an acceptable amount, a notification is issued to inform the user that an adjustment of the bias voltage is recommended. Such a notification may be a visual and/or an auditory signal.

In some embodiments, more than two viable ion signal intensities associated with an analyte ion are acquired, where each ion signal intensity is acquired at a different discriminator threshold voltage. The viable ion intensities are utilized to determine whether the bias voltage is different from an optimal bias voltage by more than an acceptable amount. By way of example, in some embodiments, the ion signal intensities are multiplied to generate a composite ion intensity, which is then compared with a reference value.

The acquisition of the ion signal intensities at different discriminator threshold values can be performed sequentially or substantially concurrently. In some cases, a method according to the present teachings for examining a bias voltage applied to an ion detector can be performed in real-time, i.e., during an experimental run, e.g., in a time period between elution of different analytes from an LC column.

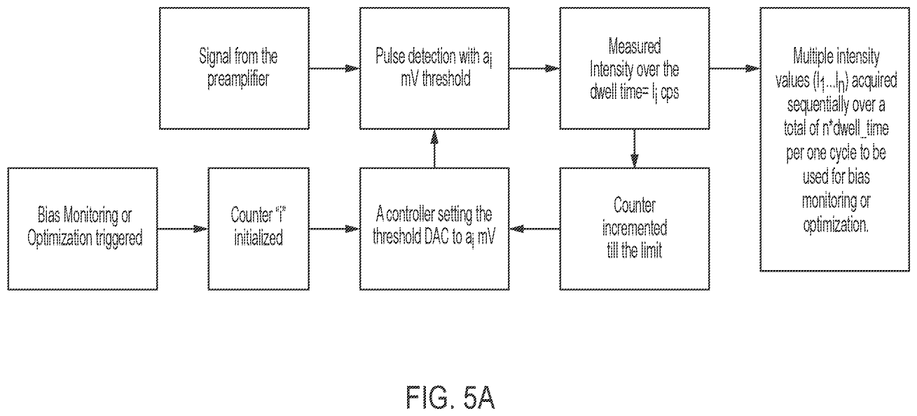

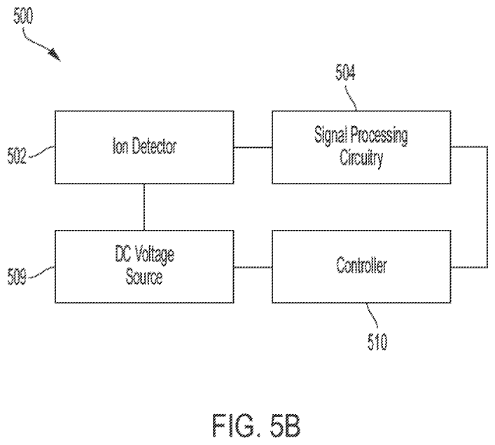

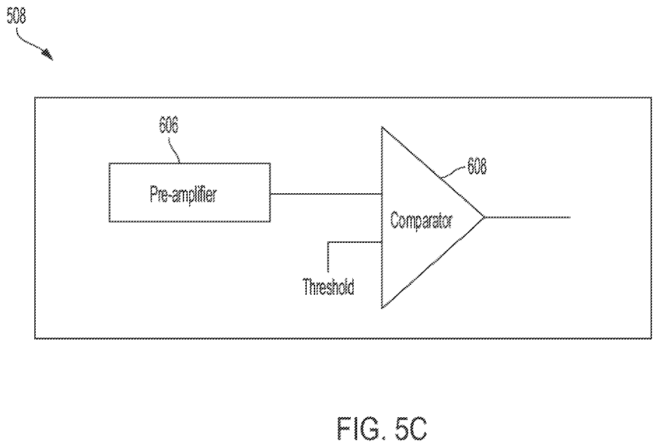

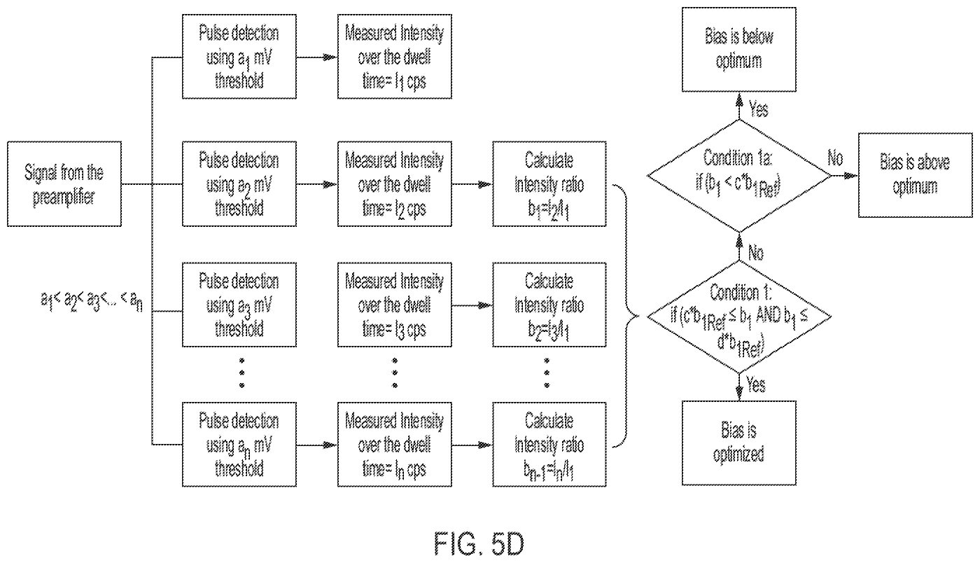

FIG. 5A is a flow chart depicting various steps in an implementation of a method according to an embodiment of the present teachings in which a plurality of ion signal intensities at different discriminator threshold values is sequentially acquired. In this embodiment, the method includes initiating the monitoring of a bias voltage applied to an ion detector. A number of viable ion intensity measurements can be performed at a plurality of different discriminator threshold values (in the example, an index ‘i’ is used to denote one of these measurements at a discriminator threshold voltage aᵢ). More specifically, an ion detection signal (e.g., which can be in the form of a voltage pulse) generated by the ion detector with the bias voltage applied thereto can be amplified, e.g., via a preamplifier, to generate an amplified voltage pulse. The amplified voltage pulse can be inputted into a discriminator (e.g., an operational amplifier) having a discriminator threshold (aᵢ mV) to acquire a viable ion signal intensity (Iᵢ).

By way of illustration, FIGS. 5B and 5C depict an example of a system 500 according to an embodiment for examining, adjusting and/or maintaining a bias voltage applied to an ion detector of a mass spectrometer, by sequentially measuring a plurality of viable ion signal intensities corresponding to a plurality of different discriminator threshold values and analyzing the measured viable ion signal intensities in accordance with the present teachings.

The system 500 includes an ion detector 502 that generates ion detection signals in response to detection of ions incident thereon and a signal processing circuitry 504 that receives the ion detection signals generated by the ion detector and processes those signals to generate a plurality of viable ion detection signals. For example, in this implementation, the signal processing circuitry 504, among other elements, can include an amplifier 606 that can amplify the ion detection signals generated by the ion detector. In other embodiments, the amplifier can be integrated with the ion detector, rather than being part of a separate signal processing circuitry.

A discriminator 508 (FIG. 5C), in the form of a comparator (e.g., an operational amplifier) in this implementation, can receive the amplified signal and compare the amplified signal with a discriminator threshold voltage to determine whether the amplified signal corresponds to a viable signal, e.g., whether the amplified ion signal is greater than the discriminator threshold voltage by a predefined margin.

With particular reference to FIG. 5B, a DC voltage source 509 operating under control of a controller 510 can apply an adjustable bias voltage to the ion detector. The controller 510 can be programmed to initiate and perform examination of the bias voltage by sequentially applying two or more discriminator threshold voltages to the comparator (See, FIG. 5C) to generate ion signals corresponding to those discriminator threshold values, which can be processed by the signal processing circuitry.

The controller 510 can also receive the processed signals (e.g., amplified voltage pulses) from the signal processing circuitry and can be programmed to analyze the viable ion detection signals acquired at different discriminator threshold values in accordance with the present teachings to determine if an adjustment of the bias voltage applied to the detector is required. The controller can also be configured to provide one or more control signals to the adjustable DC voltage source 509, when an adjustment of the bias voltage is required, to cause the DC voltage source to adjust the DC bias voltage applied to the ion detector. In some embodiments, the controller can have access to a look-up table (either loaded on the controller itself or stored in a separate database) that provides correction voltages by which a bias voltage should be changed for various ratios of signal intensities obtained at different discriminator threshold values.

FIG. 5D is a flow chart depicting various steps in an embodiment of a method according to the present teachings in which a plurality of ion signal intensity measurements at different discriminator threshold values are obtained, for example, over a plurality of dwell times. By way of illustration, the discriminator threshold values are illustrated as a₁, . . . , aₙ, and the measured ion signal intensity values are illustrated as I₁, . . . , Iₙ (ion counts per second).

In this embodiment, the ratio of two ion intensity measurements (e.g., b₁) or a mathematical average of a number of ion intensity ratios relative to a respective reference (a mathematical average of bᵢ/b_{iRef}) or a subset of the ion intensity ratios (i.e., a subset of b₁, b₂, bₙ₋₁) can be employed in conditions 1 and 1a in which scaling parameters c and d are used to establish a tolerance for deviation from target values to determine whether an adjustment of the bias voltage is required. The scaling parameters c and d can be selected, e.g., based on a particular application. By way of example, the scaling parameter c and d can be, respectively, 0.9 and 1.1 for +/−10% deviation from a reference (target value) of b_{iRef}.

By way of further illustration, in another embodiment, a bias voltage ramp (e.g., between 800 volts to 2000 volts) can be applied by increasing the bias voltage by a plurality of discrete steps to generate a plurality of discrete bias voltages, and ion detection intensity ratios (bᵢ) at each discrete bias voltage relative to a respective ion detection intensity acquired for an optimal bias voltage as well as for one or more bias voltages above and one or more bias voltages below the optimal bias voltage can be measured to generate a plurality of reference intensity ratios b_{1f}, b_{2f}, . . . , b_{n-1f}.

A single reference value can be established as B_{f}=w₁*b_{1f}*w₂*b_{2f}* . . . wₙ₋₁*b_{n-1f}, where wᵢ are the pre-established weight factors used to control the impact of each region of peak height distribution on the optimization. As an example, these wᵢ values can be all set to 1. In another example, the signal reference value can be obtained using the following: B_{f}=w₁*b_{1f}*w₂*b_{2f}* . . . wₙ₋₁*b_{n-1f}, where wᵢ=1/b_{if}, which results in B_{f}=1.

A look-up table is created during the ramp at each bias voltage value, such as Table 1 below:

TABLE 1

| (Bias-Optimum Bias) | . . . | −150 | −100 | −50 | 0 | 50 | 100 | 150 | . . . |
|---|---|---|---|---|---|---|---|---|---|
| Reference Value | . . . | B₋₁₅₀ | B₋₁₀₀ | B₋₅₀ | B_{f} | B₅₀ | B₁₀₀ | B₁₅₀ | . . . |

During bias monitoring and adjustment stage, a bias voltage corresponding to a ratio of ion detection intensities (herein denoted as B_{unknown}) is calculated as B_{unknown}=w₁*b₁*w₂*b₂* . . . wₙ₋₁*bₙ₋₁, and compared to values in the table to determine the bias voltage delta.

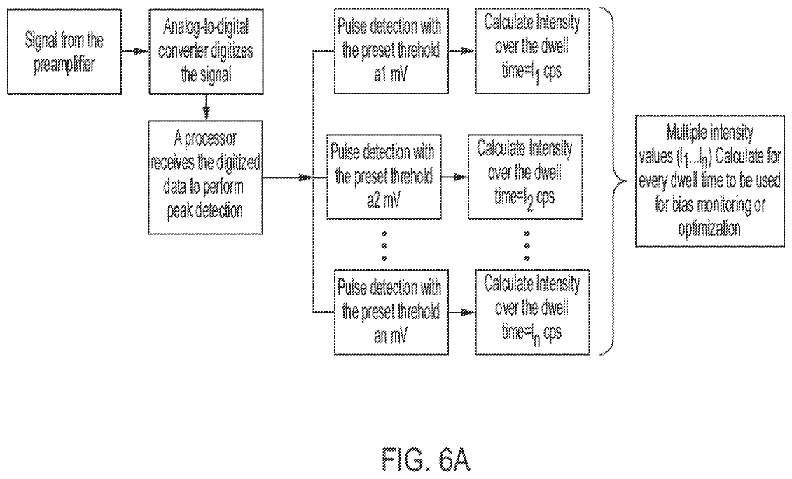

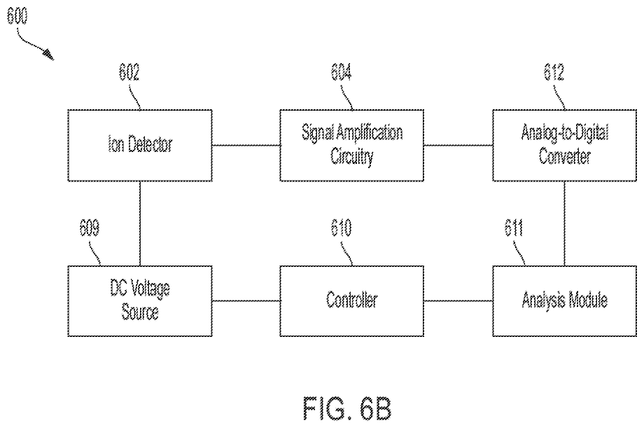

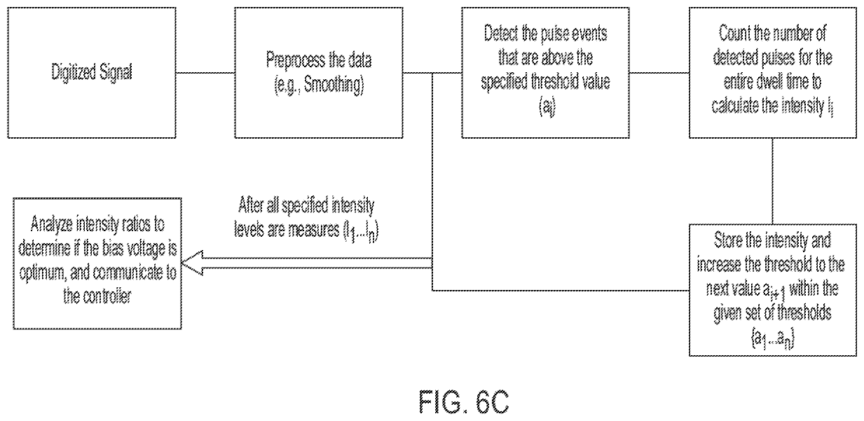

In some embodiments, an ion detection signal generated by an ion detector can be digitized and the digitized signal can be processed in a manner discussed below to determine whether an adjustment of a bias voltage applied to the ion detector is required. By way of example, with reference to the flow chart of FIG. 6A, in such an embodiment, an ion detection signal generated by an ion detector can be amplified and the amplified signal can be digitized to generate a digital ion signal. The digital ion signal can then be processed relative to each of a plurality of discriminator threshold values to generate a plurality of ion signal intensities each corresponding to one of those discriminator threshold values. The ion signal intensities can then be utilized to determine whether an adjustment of the bias voltage is required, i.e., whether the bias voltage deviates from an optimal value by more than an acceptable amount. For example, the computed ion intensities can be multiplied to generate a composite ion signal intensity and the composite ion signal intensity can be compared with a reference to determine whether an adjustment of the bias voltage is needed.

FIG. 6B shows a system 600 according to an embodiment for implementing the above digital method of examining a bias voltage applied to an ion detector. The system 600 includes an ion detector 602 that can generate ion detection signals in response to incidence of ions thereon and a signal amplification circuitry 604 that receives the ion detection signals generated by the ion detector and amplifies the received ion detection signals to generate amplified ion detection signals. As noted above, in some embodiments, the amplifier can be integrated with the ion detector circuitry while in others, the amplification circuitry can be implemented as a separate unit outside the vacuum chamber in which the ion detector is positioned.

An analog-to-digital converter (ADC) 612 receives the amplified ion detection signals and digitizes the amplified signals to generate digital ion detection signals. An analysis module 611 receives the digital signals and processes the digital signals in accordance with the present teachings to determine whether an adjustment of the bias voltage is required. For example, the analysis module 611 can be configured to identify a digitized ion detection voltage pulse as a viable ion detection signal when a predefined number of digitized voltage values associated with the voltage pulse exceed the discriminator threshold value.

By way of further illustration, FIG. 6C shows an example of processing a digitized signal generated by digitizing an ion detection signal generated by an ion detector in accordance with an embodiment of the present teachings. The digitized signals undergo a pre-processing step, e.g., data smoothing, and the processed digital signals are compared with a specified discriminator threshold value (aᵢ) during a dwell time to identify the voltage pulse events that exceed the discriminator threshold value (herein also referred to as viable detections signals or viable voltage pulses). The number of the viable voltage pulses is counted during an entire dwell time to compute the intensity (Iᵢ) associated with that discriminator threshold value. Further, the computed ion signal intensities are stored and the discriminator threshold value is advanced to the next value and the process is repeated until measurements associated with a predefined number of different discriminator threshold values are performed.

Subsequently, the ion signal intensities acquired at different discriminator threshold values are processed in a manner discussed herein, e.g., via analysis of the ratios of the ion signal intensities, to determine whether a bias voltage applied to the ion detector is within an acceptable tolerance range of an optimal setting for the bias voltage.

For example, the ion signal intensities can be compared with a reference to determine whether an adjustment of the bias voltage is required. For example, as noted above, in some embodiments, the ion signal intensities obtained at different discriminator threshold values can be multiplied to generate a composite ion signal intensity and the composite ion signal intensity can be compared with a reference to determine whether an adjustment of the bias voltage is needed.

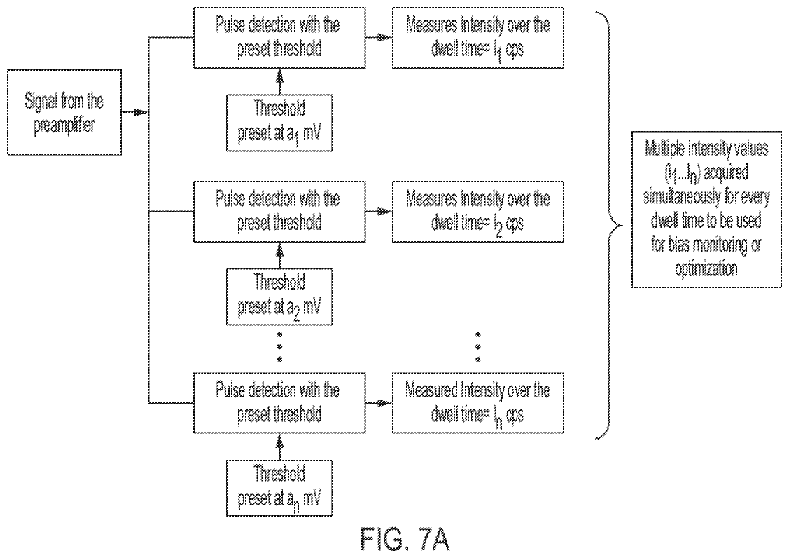

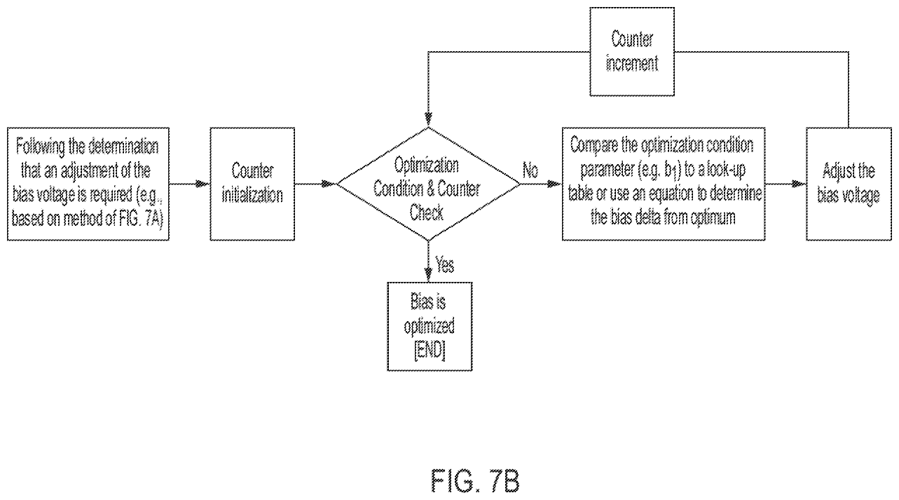

In some embodiments, the acquisition of a plurality of ion signal intensities each at a different discriminator threshold value can be performed substantially concurrently. By way of illustration, FIG. 7A schematically depicts an example of an implementation of such an embodiment. An ion detection signal (e.g., a signal in the form of a voltage pulse) can be amplified and the amplified signal can be divided among a plurality of parallel measurement channels, where each channel is configured to compare a received amplified signal relative to a different discriminator threshold (herein referred to as a₁, . . . , aₙ mV), to generate a plurality of viable ion signal intensities (herein referred to as I₁, . . . , Iₙ), each of which corresponds to a different discriminator threshold.

Similar to the previous implementation, the ion signal intensities Iᵢ can be utilized to determine whether an adjustment of the bias voltage is needed. For example, the ion signal intensities can be multiplied to generate a composite ion signal intensity and the composite ion signal intensity can be compared with a reference value to determine whether an adjustment of the bias voltage is required, e.g., whether the deviation of the bias voltage from an optimal value is sufficiently large to warrant a correction thereof.

As shown schematically in FIG. 7B, following a determination that a measured bias voltage deviates from an optimal bias voltage by more than an acceptable amount, a controller can be initialized to determine a corrective voltage that would be required to adjust the bias voltage, which has been determined to deviate from an optimal value. A counter tracks the measurements by advancing the index i after each measurement at a discriminator threshold is completed. Once the counter reaches a predefined maximum number, the measurement cycle is terminated.

The ion signal intensities Iᵢ can be utilized to determine whether an adjustment of the bias voltage is needed. For example, the ion signal intensities can be multiplied to generate a composite ion signal intensity and the composite ion signal intensity can be compared with a reference value to determine whether an adjustment of the bias voltage is needed, e.g., whether the deviation of the bias voltage from an optimal value is sufficiently large to warrant a correction thereof.

In some embodiments, the methods and systems according to the present teachings can be utilized in real-time during mass analysis of a compound to dynamically adjust a bias voltage applied to an ion detector. For example, each ion detection signal generated by the ion detector can be compared with two or more discriminator threshold values and the ratios can be analyzed in real time to determine whether an unacceptable drift of the bias voltage has occurred. When such a drift of the bias voltage is detected, a correction voltage can be applied to the bias voltage to bring the bias voltage within an acceptable range of an optimal value based on the present teachings.

In another embodiment, the bias voltage applied to the ion detector can be periodically monitored during mass analysis of a compound to determine whether the bias voltage has drifted from its optimal setting by more than a tolerance value. In some embodiments, such periodic monitoring of the bias voltage can be performed based on a predefined schedule.

In some embodiments, rather than monitoring and adjusting the bias voltage during a sample run, the obtained ion signal intensities can be analyzed in post-processing of acquired data to correct for deviations of the bias voltage, if any, during mass data acquisition.

By way of another example, in some embodiments, a bias voltage ramp (e.g., between 800 volts and 2000 volts) can be applied and intensity values at a default measurement discriminator threshold value can be collected at each voltage step of the ramp for establishing intensity scaling factor values.

Given the intensity value of I₁ at the default measurement discriminator threshold value of a₁, scaling factors can be obtained by dividing the intensity value at the optimal bias voltage, i.e. I_{1f}, by the intensity value at each step of the voltage ramp I_{1(ΔV)}, where ΔV is the difference between the bias voltage at a particular step and the optimal bias voltage.

A look-up table, such as Table 2 below, can be created during such a voltage ramp at each bias voltage value including both the reference values and the intensity scaling factor:

TABLE 2

| (Bias-Optimum Bias) | . . . | −150 | −100 | −50 | 0 | 50 | 100 | 150 | . . . |
|---|---|---|---|---|---|---|---|---|---|
| Reference Value | . . . | B₋₁₅₀ | B₋₁₀₀ | B₋₅₀ | B_{f} | B₅₀ | B₁₀₀ | B₁₅₀ | . . . |
| Intensity Scaling Factor | . . . | I_{1f}/I₁₍₋₁₅₀₎ | I_{1f}/I₁₍₋₁₀₀₎ | I_{1f}/I₁₍₋₅₀₎ | I_{1f}/I_{1f} | I_{1f}/I₁₍₅₀₎ | I_{1f}/I₁₍₁₀₀₎ | I_{1f}/I₁₍₁₅₀₎ | . . . |

During post-processing stage with concurrent intensity measurements at different threshold values, an unknown ion intensity parameter, e.g., a ratio of two ion detection intensities, (B_{unknown}) can be compared to values in the table to determine a deviation of the bias voltage (bias voltage delta) relative to an optimal bias voltage. Intensity corrections can then be determined (e.g., in the form of a scaling factor) and applied to the measured ion intensities by multiplying the intensity scaling factor for the established bias voltage delta to the measured intensity value. I_{corrected}=I_{measured at ΔV}*(Intensity Scaling Factor at ΔV)

The methods and systems according to the present teachings provide distinct advantages relative to conventional ways of monitoring and adjusting a bias voltage applied to an ion detector. By way of example, in some embodiments, a method according to the present teachings can be utilized to automatically optimize a bias voltage applied to an ion detector of a mass spectrometer without user intervention. Further, the practice of the present teachings does not require the injection of a particular analyte for optimizing the bias voltage. In addition, in many cases, a method according to the present teachings can be substantially immune to ion beam instabilities. Moreover, as discussed above, a method according to the present teachings can be used to warn a user of the mass spectrometer when the bias voltage drifts away from an optimal value by more than an acceptable amount. In some embodiments, a method according to the present teachings can be used to correct the bias voltage at specified points during a sample run. Further, in some embodiments, a method according to the present teachings can be used to correct measured ion intensity values in real-time or in a post-processing step by computing a scaling factor based on the measured deviation of the bias voltage relative to an optimal value.

Another advantage of a method according to the present teachings is that it can be executed faster than conventional techniques for optimizing the bias voltage. For example, in many implementations, a method according to the present teachings for optimizing the bias voltage can be performed in less than a few seconds.

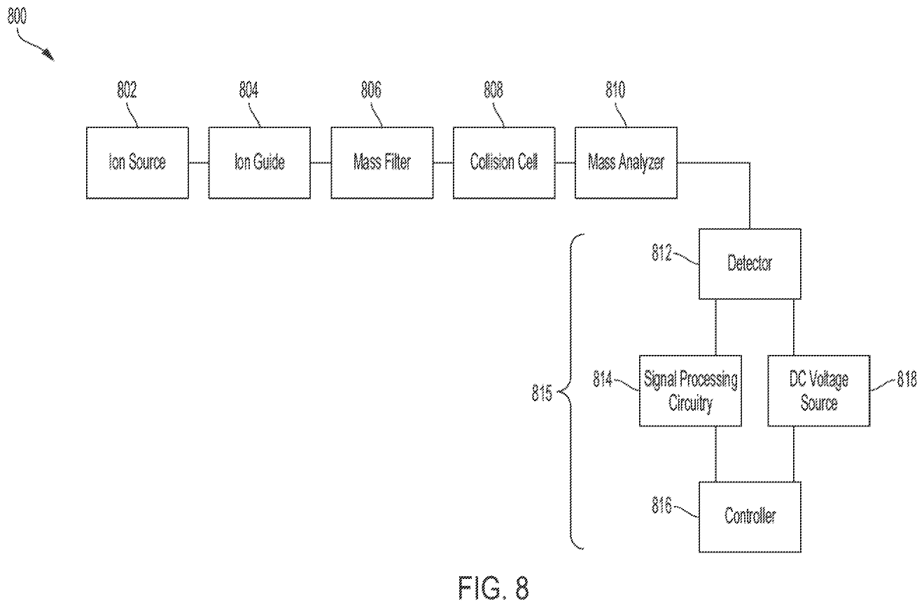

The methods and systems according to the present teachings can be incorporated in a variety of different mass spectrometers. By way of example, FIG. 8 schematically depicts such a tandem mass spectrometer 800, which includes an ion source 802 for generating a plurality of ions via ionizing one or more analytes in a sample under analysis. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions can be received by an ion guide, which forms an ion beam, which is then received by a mass filter 806, which can be configured to select precursor ions having a desired m/z ratio. The mass spectrometer 800 further includes a collision cell 808 that receives the precursor ions and cause fragmentation thereof to generate a plurality of product ions. The product ions can be received by a downstream mass analyzer 810, which can help generate a mass spectrum of the product ions. More specifically, the ions passing through the mass analyzer 810 are incident on an ion detector 812, which generates ion detection signals in response to the detection of the incident ions. The ion detection signals generated by the ion detector can be processed in a manner known in the art and as informed by the present teachings to generate a mass spectrum of the product ions.

The illustrated mass spectrometer includes a system 815 according to an embodiment of the present teachings for monitoring and/or adjusting a bias voltage applied to the ion detector via an adjustable DC voltage source 818. In particular, a signal processing circuitry 814 can receive the ion detection signals generated by the ion detector and can process those signals (e.g., it can amplify the signals) to generate processed signals that can in turn be received via the controller 816. The controller 816 can operate on the received signals in accordance with the present teachings to determine whether an adjustment of the bias voltage is required. Further, the controller 816 can be configured to apply control signal(s) to the adjustable DC voltage source, in response to the determination that an adjustment of the bias voltage is required, to bring the bias voltage within an acceptable range of an optimal bias voltage value.

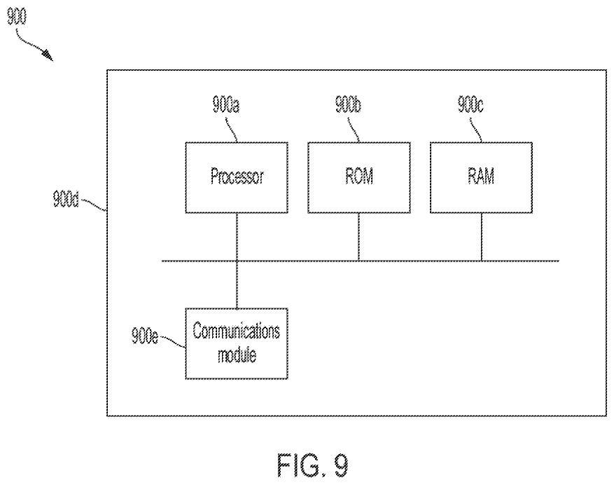

The systems according to the present teachings can be implemented in hardware, software and/or firmware employing techniques known in the art as informed by the present teachings. By way of example, FIG. 9 schematically depicts an example of an implementation of such a controller 900, which includes a processor 900a (e.g., a microprocessor), at least one permanent memory module 900b (e.g., ROM), at least one transient memory module (e.g., RAM) 900c, and a bus 900d, among other elements generally known in the art.

The bus 900d allows communication between the processor and various other components of the controller. In this example, the controller 900 can further include a communications module 900e that is configured to allow sending and receiving signals.

Instructions for use by the controller 900, e.g., for determining whether an adjustment of the bias voltage is required and for applying appropriate control signals to the adjustable DC voltage source, can be stored in the permanent memory module 900b and can be transferred into the transient memory module 900c during runtime for execution. The controller 900 can also be configured to control the operation of other components of the mass spectrometer, such as the ion guide, and mass analyzer, among others. By way of example, an analysis module, such as the above analysis module 611, can also be implemented in a similar manner.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill in the art will appreciate that various changes can be made to the above embodiments without departing from the scope of the present teachings.

What is claimed is:

1. A method for examining a bias voltage applied to an ion detector of a mass spectrometer, comprising:
(1) using the ion detector to acquire at least two viable ion detection signals corresponding to at least two different discriminator threshold values, and
(2) using said at least two viable ion detection signals to determine whether an adjustment of a bias voltage applied to the ion detector is required.

2. The method of claim 1, wherein said step of using said at least two viable ion detection signals to determine whether the adjustment of said bias voltage is required comprises comparing a ratio of intensities of said at least two viable ion detection signals with a reference value to determine whether said ratio lies within a predefined tolerance range about said reference value.

3. The method of claim 2, wherein an adjustment of said bias voltage is required when said ratio lies outside said predefined tolerance range.

4. The method of claim 2, wherein said tolerance range has a value in a range of about 5% to about 50% of the reference value.

5. The method of claim 1, further comprising adjusting the bias voltage by increasing or decreasing the bias voltage by a corrective voltage when the adjustment of the bias voltage is required so as to generate an adjusted bias voltage and applying said adjusted bias voltage to said ion detector, and further optionally comprising obtaining said corrective voltage from a look-up table containing a plurality of corrective voltages corresponding to a plurality of ratios of intensities of said at least two viable ion detection signals.

6. The method of claim 5, further comprising performing said steps (1)-(2) using the adjusted bias voltage as the bias voltage applied to the ion detector to determine whether additional adjustment of the adjusted bias voltage is required.

7. The method of claim 1, wherein said ion detector comprises any of a channel electron multiplier, a discrete dynode multiplier, a microchannel plate detector, and a hybrid ion detector and wherein said mass spectrometer comprises any of a time-of-flight mass analyzer, a quadrupole mass analyzer or a combination thereof.

8. The method of claim 1, further comprising generating a notification when an adjustment of the bias voltage is required and wherein optionally said notification comprises any of a visual, an auditory notification or a combination thereof.

9. The method of claim 1, wherein said step of using the ion detector to acquire at least two viable ion detection signals is initiated at one or more times during a mass spectrometric analysis of at least one compound, and wherein optionally said one or more times are defined by a user.

10. The method of claim 1, wherein said step of using the ion detector to acquire at least two viable ion detection signals is initiated after detection of a predefined accumulated number of ions by the ion detector or after passage of a predefined time subsequent to triggering of the ion detector to begin detecting ions.

11. The method of claim 1, wherein the step of acquiring any of said at least two viable ion detection signals comprises:
amplifying an ion detection signal generated by the ion detector in response to detection of ions incident thereon, and
comparing the amplified signal relative to a discriminator threshold and identifying the ion signal as a viable ion signal when at least a predefined portion of the ion signal exceeds the discriminator threshold.

12. The method of claim 1, wherein the step of acquiring any of said at least two viable ion detection signals comprises:
amplifying an ion detection signal generated by the ion detector in response to detection of ions incident thereon to generate an amplified signal,
digitizing the amplified signal to generate a digital ion detection signal,
characterizing said digital ion detection signal as a viable ion detection signal when said digital ion detection signal satisfies predefined criteria, and
for each of the plurality of discriminator threshold values, counting viable ion detection signals obtained at said discriminator threshold value to compute an ion intensity associated with said discriminator threshold value.

13. The method of claim 12, wherein said predefined criteria requires the digital ion detection signal exhibit an amplitude above the respective discriminator threshold for at least a predefined portion of said digital ion detection signal to be identified as a viable ion detection signal, and wherein optionally said predefined portion of the digital ion detection signal is acquired during a time period in a range of about 0.1 nanosecond to about 10 nanoseconds.

14. The method of claim 9, wherein said at least one compound comprises a plurality of compounds introduced into the mass spectrometer in a batch processing mode.

15. A system for monitoring a bias voltage applied to an ion detector of a mass spectrometer, comprising:
a signal processing circuitry configured to receive ion detection signals generated by the ion detector in response to detection of ions incident thereon and to amplify said ion detection signals to generate a plurality of amplified ion detection signals, and
a controller in communication with said signal processing circuitry for receiving said amplified signals, said controller being configured to process said amplified ion detection signals to identify a plurality of viable ion detection signals corresponding to a plurality of different discriminator threshold values,
wherein said controller is further configured to compute intensities of said viable ion detection signals at said plurality of different discriminator threshold values and process said ion intensities to determine whether an adjustment of said bias voltage is required.

16. The system of claim 15, further comprising an adjustable DC voltage source in communication with said controller and configured to supply said bias voltage to the ion detector.

17. The system of claim 16, wherein said controller is configured to provide a control signal to said adjustable voltage source when an adjustment of said bias voltage is required to cause the voltage source to adjust the bias voltage, and wherein optionally said controller is in communication with a database to access a corrective bias voltage and is configured to provide said corrective bias voltage to said adjustable voltage source via said control signal.

18. A system for monitoring a bias voltage applied to an ion detector of a mass spectrometer, comprising:
a signal processing circuitry configured to receive ion detection signals generated by the ion detector in response to detection of ions incident thereon and to amplify said ion detection signals to generate a plurality of amplified ion detection signals,
an analog-to-digital converter (ADC) configured to receive said amplified ion detection signals and to digitize said received signals to generate a plurality of digital ion detection signals, and
an analysis module in communication with said ADC to receive said digital ion detection signals and process said digital ion detection signals to determine whether an adjustment of the bias voltage is required.

19. The system of claim 18, wherein said analysis module is configured to compare said digital ion detection signals with a plurality of different discriminator threshold values to generate a plurality of viable ion detection signals.

20. The system of claim 19, wherein said analysis module is further configured to compute intensities of said viable ion detection signals and to process said intensities relative to a reference to determine whether an adjustment of said bias voltage is required.
